(19) United States
(12) Patent Application Publication
(10) Pub. No.: US 2006/0247955 A1
(43) Pub. Date: Nov. 2, 2006

(54) Method and system for providing free passes for gaming tournaments

(75) Inventor: Charles Humphrey, Lakewood, CO (US)

Correspondence Address: STEPHEN M. NIPPER;DYKAS, SHAVER & NIPPER, LLP, PO BOX 877, BOISE, ID, 83701-0877, US

(73) Assignee: I'm All-In, LLC, Saddle River, NJ (US)

(21) Appl. No.: 11/221,046

(22) Filed: Sep. 7, 2005

Related U.S. Application Data
(60) Provisional application No. 60/670,945, filed on Apr. 12, 2005.

(51) Int. Cl. G06Q 10/00

(52) U.S. Cl. 705/5

(57) ABSTRACT

A method and system for admitting players to a gaming tournament, where applications for free passes for the gaming tournament are allowed, but which must be made before the end of a predetermined period of time before the gaming tournament. Admittance to the gaming tournament is opened at a predetermined period of time before the start of the gaming tournament to both paying participants and those with free passes on a first-come, first-served basis. The said gaming tournaments are preferably poker tournaments, slot machine tournaments, 21 tournaments, gin rummy tournaments, backgammon tournaments, other card-game tournaments, board game tournaments, electronic game tournaments, video game tournaments, casino game tournaments, etc.

### PRIORITY

This application claims the priority date of, and incorporates by reference, the provisional application entitled METHOD AND SYSTEM FOR PROVIDING FREE PASSES FOR GAMING TOURNAMENTS filed by Charles Humphrey on Apr. 12, 2005 with application serial number 60/670,945.

### BACKGROUND OF THE INVENTION

1. Field of the Invention

The preferred embodiment of the present invention relates to gaming tournaments, including but not limited to slot machine tournaments, roulette tournaments, poker and other card game gaming tournaments, etc. More particularly, the present invention relates to a method and system for providing free passes for gaming tournaments such as poker tournaments and/or the like.

2. Background Information

Many promotional contests are held every day. They circumvent the anti-gambling laws in many states by offering a means to obtain a free game piece or entry to those who would like to enter the contest but do not want to pay for a sandwich, a box of product, a basket of groceries or the like. The free game pieces are given out in various ways, including but not limited to mailing a self-addressed stamped envelope to a certain address, asking a store manager for a game piece, allowing a free game piece to be requested via the Internet, via fax machine, toll-free number, etc.

Recently there has been a nationwide increase in the passion for gaming tournaments driven principally by the cablecasted television shows like the WORLD POKER TOUR® and the WORLD SERIES OF POKER®, as well as the increasing popularity of online casinos and card rooms. A number of developments have happened: numerous amateur gaming leagues have been formed; business proprietors, such as owners of bars, restaurants, and entertainment venues have begun to offer gaming tournaments as a means to attract customers; and trade show operators have begun to offer gaming tournaments as a means to draw attendance at the related trade show.

In order to avoid state anti-gambling statutes, these tournaments are usually held without the players having to pay any entry fee or other consideration (such as a door charge, food or beverage minimum or otherwise obligate a player to pay any consideration) in order to be allowed to play.

However, if the ability to enter and play in a gaming tournament were initially conditioned on the players paying a consideration, but the potential players in such a tournament were also provided with an alternative reasonable means to avoid paying that consideration and get an entry into the gaming tournament for free, then, similarly to the requirements in promotional contests, it would be permissible under certain anti-gambling laws to require players who do not take advantage of the alternative means of entry offered, to pay the required consideration.

Such a way of providing free entry into the tournament would emulate the “promotional” contests mentioned in the background art. That is, the league, business proprietor or tradeshow operator would provide an alternative means to enter without having to pay any consideration. Such alternative means include a potential player accessing a website to request a free pass, using the mail to request a free pass, applying for a free pass over a telephone line or in person at a fixed physical location or any other reasonable means to make such a request. In any such event, the free pass would be required to be requested at a stipulated period of time prior to the scheduled start of the subject activity and would then be made available for use by the potential player at the venue where the tournament is to be held some reasonable period of time before the gaming tournament starts.

What is needed is a method/apparatus comporting with state anti-gaming laws that allows those hosting a gaming tournament to require some or all of the players to pay a consideration (door fee, food/drink minimum, etc.) in order to be allowed to play in the gaming tournament. Embodiments of the present invention address this need.

Additional objects, advantages and novel features of the invention will be set forth in part in the description that follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The preferred embodiment of the present invention comprises both a method for admitting players to a gaming tournament as well as (in other embodiments) a system for admitting players to gaming tournaments.

The preferred embodiment of the method of the present invention comprises a number of steps. First, offering a means to obtain a free pass to play in a given tournament or tournaments. Second, receiving at least one request from a first group of players for a free pass to enter such tournament(s). Third, providing the free pass(es) to the first group of players. Fourth, closing the period during which free passes can be requested and obtained for the said tournament(s). Fifth, opening general registration for said gaming tournament(s). Sixth, admitting players who desire to play in the said tournament(s) on a first-come, first-served basis until the available spaces in the tournament(s) are filled, charging those who do not have free passes the amount of consideration associated with the said tournament(s).

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the description of the preferred embodiment is to be regarded as illustrative in nature, and not as restrictive in nature.

### DESCRIPTION OF THE PREFERRED EMBODIMENTS

While the invention is susceptible of various modifications and alternative constructions, certain embodiments will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

The preferred embodiment of the present invention is a method and apparatus (system) for providing/creating/running a gaming tournament that charges consideration (door fee, food/drink minimums, etc.) for entry into the gaming tournament. This method/apparatus is accomplished in a manner that comports with certain state anti-gambling laws by providing for alternative entry methods into the gaming tournament.

In the preferred embodiment of the present invention, during some predetermined period of time before the tournament begins, an individual desiring to play in the tournament is allowed to submit a request for a free pass. The request preferably submitted to the entity running the gaming tournament (for purposes of this discussion the term “entity” is intended to include any business, corporation, partnership or individual providing, hosting, soliciting, running, etc. said tournament). This submission could be in any number of logical ways, including but not limited to via a server computer, through obtaining, completing and turning in an entry form at the location of the tournament or some other physical location, via electronic mail, via an Internet webpage, via fax, via first class mail, via deliver in person, or by any other suitable means.

Then, after a predetermined period (or less) of time has passed, the ability of a player to request and receive a free pass preferably closes. This predetermined period of time may be any reasonable time interval determined by the entity.

Then, a predetermined period of time before the tournament begins, registrations for the available spaces in the tournament are accepted on a first-come, first-served basis from those with free passes and from those players who don't have free passes but elect to pay the consideration charged to players who do not have free passes.

Through this process, a player wishing to play in said tournament can enter at least two ways, namely by (1) obtaining a free pass ahead of time or by (2) paying consideration at the time of the tournament.

The present invention is adaptable to a number of different sub-embodiments that are obvious renditions upon the present invention's core concepts. For purposes of explanation, the Applicant provides the following additional example, again noting that the present invention is not limited to this explicit example.

### EXAMPLE A

Entity is holding a poker tournament. Applications for a free pass are made available at the premises of the entity and/or over the Internet. Potential players send the completed application to the entity via postal mail, e-mail or Internet communication. The requested free passes are then made available to the potential player by return postal mail, e-mail or by making them available at a physical location designated by the entity. Potential players are thus given the opportunity to receive a free pass for the poker tournament. All requests for a free pass must be received at a designated time before the start of the tournament, say no later than one week before the tournament. Entrants who did not pre-register are allowed to register at the door and pay consideration (such as a door charge or by paying for a food/drink minimum, etc.). At a predetermined time before the start of the tournament, say two hours, holders of free passes and all entrants willing to pay the stated consideration are admitted to the tournament on a first-come, first-served basis.

### EXAMPLE B

Entity is holding a poker tournament. The poker tournament has forty (40) seats available to players. Applications for a free pass are made available at the premises of the entity and/or over the Internet. Potential players send the completed application to the entity via postal mail, e-mail or Internet communication. The requested free passes are then made available to the potential player by return postal mail, e-mail or by making them available at a physical location designated by the entity. Potential players are thus given the opportunity to receive a free pass for the poker tournament. All requests for a free pass must be received at a designated time before the start of the tournament, say no later than one week before the tournament. “First come, first served” registration is used to determine who gets the forty seats. Two hours before the tournament, registration opens. The first forty people to register are allowed entry into the tournament. Registrants with free passes are allowed into the tournament without needing to pay consideration. Registrants who do not have free passes must pay consideration (such as a door charge or by paying for a food/drink minimum, etc.) to enter the tournament. Once the forty seats are taken (all by players holding free passes, all by players paying consideration, or any combination thereof), registration closes and no more players are admitted to the tournament.

This disclosure refers to the preferred embodiment used to determine participants in a game and/or gaming tournament. While this is the preferred embodiment, the present invention is obviously not limited in application only to games/gaming tournaments. But when the terms “game”/“gaming tournament” are used, in the preferred embodiment such terms refer to games of chance and games of skill, including but not limited to card game tournaments, board game tournaments, slot machine tournaments, poker tournaments, 21 tournaments, gin rummy tournaments and backgammon tournaments.

As will readily be appreciated by those skilled in the art, numerous modifications and variations of the above embodiments of the present invention are possible without departing from the scope of the invention. While the above steps are mentioned in a particular order, such steps could be performed in any order so desired by the entity.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A method for determining the participants of an event having a limited number of seats, said participants comprising paying participants who paid consideration to participate and nonpaying participants who did not pay consideration to participate, said method comprising the steps of:
providing applications for free passes to participate in the event a first predetermined period of time before the start of said event, said free passes allowing said participant to participate without paying consideration;
issuing free passes to said nonpaying participants who properly applied for said free passes not later than a second predetermined period of time before the start of the event; and
opening registration for the available seats in said event and admitting, on a first-come first-served basis said nonpaying participants and those willing to pay a consideration to play in said event at a third predetermined period of time before the start of the event.

2. The method of claim 1, comprising stopping the admission of nonpaying and paying participants once a certain predetermined number of total participants has been admitted to the event.

3. The method of claim 1, wherein said distribution takes place at the location of said event.

4. The method of claim 1, wherein said distribution takes place via first class mail.

5. The method of claim 1, wherein said distribution takes place via electronic mail.

6. The method of claim 1, wherein said event is a gaming tournament.

7. The method of claim 6, wherein said gaming tournament is a tournament selected from the group consisting of a card-game tournament, a slot machine tournament, a roulette tournament and a board game tournament.

8. A method for determining the participants of an event having a limited number of seats, said participants comprising paying participants who paid consideration to participate and nonpaying participants who did not pay consideration to participate, said method comprising the steps of:
providing applications for free passes to participate in the event a first predetermined period of time before the start of said event, said free passes allowing said participant to participate without paying consideration;
issuing free passes to said nonpaying participants who properly applied for said free passes not later than a second predetermined period of time before the start of the event;
opening registration for the available seats in said event and admitting, on a first-come first-served basis said nonpaying participants and those willing to pay a consideration to play in said event a third predetermined period of time before the start of the event;
collecting a consideration from said paying participants; and
stopping the admission of nonpaying and paying participants once a certain predetermined number of total participants has been admitted to the event.

9. A method for determining the participants of a gaming tournament having a limited number of seats, said participants comprising paying participants who paid consideration to participate in the gaming tournament and nonpaying participants who did not pay consideration to participate in the gaming tournament, said method comprising the steps of:
providing applications for free passes to participate in the gaming tournament a first predetermined period of time before the start of said gaming tournament, said free passes allowing said participant to participate without paying consideration;
issuing free passes to said nonpaying participants who properly applied for said free passes not later than a second predetermined period of time before the start of the gaming tournament;
opening registration for the available seats in said event;
collecting a consideration from said paying participants;
admitting, on a first-come, first-served basis said nonpaying participants and said paying participants a third predetermined period of time before the start of said gaming tournament; and
stopping the admission of nonpaying and paying participants once a certain predetermined number of total participants has been admitted to the gaming tournament.
